(19) United States
(12) Patent Application Publication
(10) Pub. No.: US 2011/0154124 A1
(43) Pub. Date: Jun. 23, 2011

(54) METHOD AND DEVICE FOR PREVENTING FAILURE

(76) Inventor: Eric Blot-Lefevre, Neuilly-Sur-Seine (FR)

(21) Appl. No.: 12/992,969

(22) PCT Filed: May 12, 2009
(86) PCT No.: PCT/EP2009/055726

§ 371 Date: Feb. 15, 2011

(30) Foreign Application Priority Data
May 16, 2008 (FR) 08 02715

(51) Int. Cl. G06F 11/30

(52) U.S. Cl. 714/47.1; 714/E11.179

(57) ABSTRACT

The method of tracking the evolution of a physical quantity comprises:
a step of storing a plurality of dates of transmissions of numerical values requested by requests issued by so-called “requesting” entities destined for the same so-called “issuing” entity sending numerical values,
for each so-called transmission actually carried out subsequent to a so-called request, a step of storing the date of transmission and a step of determining the lag between the date of the actual transmission and the corresponding requested transmission date,
for each of a plurality of predetermined durations, a step of determining a statistical quantity representative of the so-called lags,
a step of determining the evolution of said statistical quantity between at least two of the so-called predetermined durations and
a step of comparing said evolution with a predetermined limit value.

This application is a national phase application under §371 of PCT/EP2009/055726, filed May 12, 2009, which claims priority to French Patent Application No. 0802715, filed May 16, 2008, the entire content of which is expressly incorporated herein by reference.

### BACKGROUND OF THE INVENTION

The present invention relates to a method of and a device for tracking the evolution of a physical quantity. It applies, in particular, to the tracking of the evolution of lags in transmission of numerical values from an entity, said lags being measured between the moment when the transmission is requested and the moment when it is actually carried out.

The detection of risks of suspension of transmissions of numerical values originating from an entity is currently too slow in relation to users' requirements. Stated otherwise, the suspension has generally already taken place when the computer systems concerned detect it.

### SUMMARY OF THE INVENTION

The present invention is aimed at remedying these drawbacks.

For this purpose, according to a first aspect, the present invention is aimed at a method of tracking the evolution of a physical quantity, comprising:
a step of storing a plurality of dates of transmissions of numerical values requested by requests issued by so-called “requesting” entities destined for the same so-called “issuing” entity sending numerical values,
for each so-called transmission actually carried out subsequent to a so-called request, a step of storing the date of transmission and a step of determining the lag between the date of the actual transmission and the corresponding requested transmission date,
for each of a plurality of predetermined durations, a step of determining a statistical quantity representative of the so-called lags,
a step of determining the evolution of said statistical quantity between at least two of the so-called predetermined durations and
a step of comparing said evolution with a predetermined limit value.

By virtue of these provisions, it is possible to detect a risk of disturbance or of suspension of transmission on the part of said entity, before it occurs. For example, the risks of failures relate to numerical values intended for actuators of physical systems or transfers of monetary values.

According to particular characteristics, in the course of the step of storing a plurality of requested transmission dates, each date requested by a plurality of “requesting” entities destined for the same “issuing” entity is stored.

Thus, the implementation of the present invention does not make it necessary to store all the dates of requests issued destined for the issuing entity. This implementation is thus simplified.

According to particular characteristics, in the course of the step of determining a statistical quantity representative of the so-called lags, an average is determined, for a so-called predetermined duration, of the lags determined in the course of the lag determination step.

The statistical quantity is therefore very easy to determine.

According to particular characteristics, in the course of the step of determining a statistical quantity representative of the so-called lags, the statistical quantity is weighted as a function of the numerical value corresponding to the request.

The significance of the numerical values in the determination of the statistical quantity is thus taken account of in the determination of the risk of suspension.

According to particular characteristics, in the course of the step of comparing said evolution with a predetermined limit value, said predetermined limit value depends on the past evolution of said statistical quantity.

Thus, a more complex evolution profile than a simple local evolution may be taken into account.

According to particular characteristics, if said evolution is greater than the predetermined limit value, a step of issuing an alarm message destined for each issuing entity that made a request whose date has been stored in the course of the step of storing dates of requests is performed.

The requesting entities can thus take measures to limit the influence of the risk, for example by limiting the numerical values which are the subjects of the requests or the lag requested for their transmissions.

According to a second aspect, the present invention is aimed at a device for tracking the evolution of a physical quantity, comprising:
a memory for storing a plurality of dates of transmissions of numerical values requested by requests issued by so-called “requesting” entities destined for the same so-called “issuing” entity sending numerical values,
a memory for storing the date of transmission of each so-called transmission actually carried out subsequent to a so-called request,
a processing module for determining the lag between the date of the actual transmission and the corresponding requested transmission date,
a processing module for determining a statistical quantity representative of the so-called lags, for each of a plurality of predetermined durations,
a processing module for determining the evolution of said statistical quantity between at least two of the so-called predetermined durations and
a processing module for comparing said evolution with a predetermined limit value.

According to a third aspect, the present invention is aimed at a computer program, comprising instructions adapted, once implemented by a computer system, for implementing the method which is the subject of the present invention, such as succinctly set forth hereinabove.

The advantages, aims and particular characteristics of this device and of this computer program being similar to those of the method which is the subject of the present invention, such as succinctly set forth hereinabove, they are not recalled here.

### BRIEF DESCRIPTION OF THE DRAWINGS

Other advantages, aims and characteristics of the present invention will emerge from the description which follows, given for explanatory and wholly non-limiting purposes in regard to the appended drawings, in which:

FIG. 1 schematically represents a particular embodiment of the device which is the subject of the present invention and

FIG. 2 represents, in the form of a logic diagram, steps implemented in a particular embodiment of the method which is the subject of the present invention.

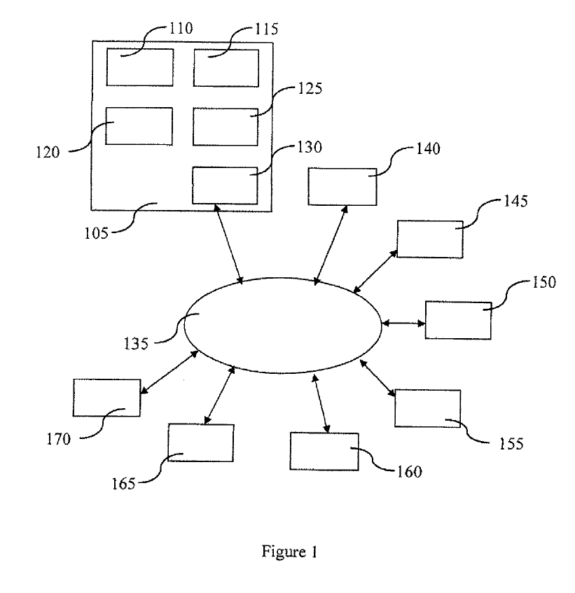

Depicted in FIG. 1 are a device 105 comprising a central unit 110, a nonvolatile memory 115, a random access memory 120, a data support reader 125 and a means of access 130 to a network 135. Requester computer systems 140, 145 and 150, issuer computer systems 155 and 160 and destination computer systems 165 and 170 are linked to the network 135.

The device 105 takes, here, the form of a computer, for example a server. The central unit 110, the nonvolatile memory 115, the random access memory 120, the data support reader 125 and the means of access 130 to the network 135 are of known type. In particular, the data support reader 125, for example for a data support taking the form of compact disks or of “keys” connectable to a port (not represented) of the device 105, is adapted, under the control of the central unit 110, for transferring data and instructions of programs from the data support to nonvolatile memory 115.

The network 135 is, for example, the Internet network.

The computer systems 140 to 170 are of known type, for example servers.

The computer systems 140, 145 and 150 are termed “requesters” because they issue requests destined for at least one issuer computer system. The computer systems 155 and 160 are termed “issuers” because they issue messages comprising numerical values requested by the requests, destined for at least one “destination” computer system 165 and 170.

It is reminded that one of the aims of the present invention is to estimate a risk of failure of transmission of numerical values by the issuer computer systems 155 and 160 before this failure arises. For example, the risks of failure relate to an issuer computer system sending numerical values intended for actuators of physical, agricultural, industrial, infrastructural, office or domestic systems, or transfers of monetary values. It is recalled that the failure can originate from numerous, technical, factors in particular an overload of data or of processes to be handled or the presence of a virus or some other malicious software, human or automatic, notably in the case of feebleness of available requested resources.

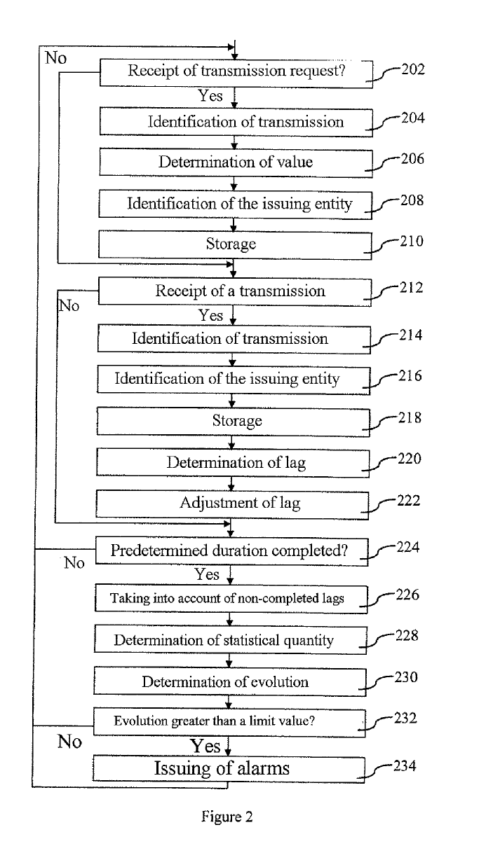

The device 105, by implementing computer program instructions held in nonvolatile memory, implements the steps illustrated in FIG. 2.

At least some of the requester computer systems (here for the computer systems 140 and 145) issue a message destined for the device 105 during the transmission of each request destined for one of the issuer systems 155 and 160, said message identifying a transmission of requested numerical value. Likewise, the destination computer systems 165 and 170 issue a message destined for the device 105 upon receipt of a numerical value corresponding to a request, said message identifying a receipt of numerical value.

As illustrated in FIG. 2, in a particular embodiment of the method which is the subject of the present invention, in the course of a step 202, the device 105 determines whether it has received a message identifying a request issued by a requester computer system destined for an issuer computer system. Else, it passes to a step 212. If yes, in the course of a step 204, the device 105 identifies a transmission of requested value. In the course of a step 206, the device 105 determines a requested numerical value. In the course of a step 208, the device 105 identifies an issuer computer system which is the destination of the request.

In the course of a step 210 the device 105 determines a requested date of transmission of the numerical value. For example, the device 105 possesses, for each pair of requester and issuer devices, a fixed lag, that it adds to the current date. According to another example, the device 105 determines, in the message received from the requesting computer system, a requested transmission lag, that it adds to the current date or a requested transmission date. The construction of such messages is of type known to the person skilled in the art, by implementing a message structure comprising several predetermined fields.

In the course of a step 210, the device 105 stores the current date, the identification of the transmission of requested value, the requested numerical value, the issuer computer system which is the destination of the request, and the requested date of transmission of the numerical value.

In the course of a step 212, the device 105 determines whether a requested transmission has been performed, as a function of at least one message originating from a destination computer system 165 and 170. Else, the device 105 passes to a step 224. If so, in the course of a step 214, the device 105 identifies the transmission of requested value concerned. In the course of a step 216, the device 105 identifies the issuer computer system which transmitted the numerical value.

In the course of a step 218, the device 105 stores the current date, the identification of the transmission of requested value and the identification of the issuer computer system.

In the course of a step 220, the device 105 determines a lag between the requested transmission date and the current date and associates it, in memory, with the identification of the numerical value and the identification of the issuer computer system.

In the course of a step 222, the device 105 deducts a possible lag due to a normal inactivity of the issuer, as a function of stored knowledge of inactivity periods. For example, if the issuer computer system or the destination computer system is inactive each night, from one hour to another, for example for maintenance, updating, data backup, running of a program for detecting and/or eliminating malicious software or reinitialization, if the requested date of transmission corresponded to a night and if the current date lies in the first minutes of the new day, the lag between the requested date and the current date is considered to be zero. Likewise, if the issuer computer system or the destination computer system is inactive during weekends, public vacations and certain “long weekends”, the current lag between the requested date of transmission and the end of the inactivity period is deducted if the transmission takes place at the end of an inactivity period.

In the course of a step 224, the device 105 determines whether a predetermined duration is completed. For example, each predetermined duration corresponds to a minute or to a month. Else, the device 105 returns to step 202. If so, in the course of a step 226, the device assigns, to each transmission whose requested transmission date has passed, the current date as date of transmission and determines the lag between these two dates as set forth in regard to steps 220 and 222.

In the course of a step 228, the device 105 determines at least one statistical quantity value representative of each lag determined in the course of steps 220, 222 and 226. For example a statistical quantity is a mean of the lags. For example, a statistical quantity is an average of the lags weighted by the requested numerical values.

In the course of a step 230, the device 105 determines an evolution, over at least two predetermined durations, of the values of each statistical quantity.

In the course of a step 232, the device 105 compares said evolution with a predetermined limit value and determines whether the evolution is greater than said predetermined limit value. For example the predetermined limit value is equal to a quarter, a third or a half of the duration separating the middle of each predetermined duration. For example, if each predetermined duration covers a month and is offset by a fortnight from the previous predetermined duration, the predetermined limit value is, in these examples, respectively equal to 3.75 days, 5 days or 7.5 days. In variants, at least one predetermined limit value is dependent on at least one past evolution of the physical quantity. For example, if in the month of August of each year, the evolution of the value of the physical quantity is +five days, the predetermined limit value is, for the month of August, increased by a fraction of these five days, for example 2.5 days.

According to another example, if the average of the positive evolutions for a predetermined duration, for example a year, is two days, a value greater than double or triple this average is fixed as limit value, for example at four or six days.

In variants, the value of the statistical quantity is taken account of and its evolution is compared with the limit value only if this value is greater than another limit value, for example “2 days”. Thus, no alarm is triggered if the delay noted is in the average over a predetermined period, for example a year or in a limited proportion.

If the result of step 232 is negative, step 202 is returned to. If the result of step 232 is positive, in the course of a step 234, the device 105 issues an alarm message destined for each of the requesting computer systems. Next, the device 105 returns to step 202.

1. A method of tracking the evolution of a physical quantity, comprising:
a step of storing a plurality of dates of transmissions of numerical values requested by requests issued by so-called “requesting” entities destined for the same so-called “issuing” entity sending numerical values,
for each so-called transmission actually carried out subsequent to a so-called request, a step of storing the date of transmission and a step of determining the lag between the date of the actual transmission and the corresponding requested transmission date,
for each of a plurality of predetermined durations, a step of determining a statistical quantity representative of the so-called lags,
a step of determining the evolution of said statistical quantity between at least two of the so-called predetermined durations and
a step of comparing said evolution with a predetermined limit value.

2. The method of claim 1, wherein in the course of the step of storing a plurality of requested transmission dates, each date requested by a plurality of “requesting” entities destined for the same “issuing” entity is stored.

3. The method of claim 1, wherein, in the course of the step of determining a statistical quantity representative of the so-called lags, an average is determined, for a so-called predetermined duration, of the lags determined in the course of the lag determination step.

4. The method as claimed in claim 1, wherein, in the course of the step of determining a statistical quantity representative of the so-called lags, the statistical quantity is weighted as a function of the numerical value corresponding to the request.

5. The method of claim 1, wherein, in the course of the step of comparing said evolution with a predetermined limit value, said predetermined limit value depends on the past evolution of said statistical quantity.

6. The method of claim 1, wherein, if said evolution is greater than the predetermined limit value, a step of issuing an alarm message destined for each issuing entity that made a request whose date has been stored in the course of the step of storing dates of requests is performed.

7. A device for tracking the evolution of a physical quantity, comprising:
a memory for storing a plurality of dates of transmissions of numerical values requested by requests issued by so-called “requesting” entities destined for the same so-called “issuing” entity sending numerical values,
a memory for storing the date of transmission of each so-called transmission actually carried out subsequent to a so-called request,
a processing module for determining the lag between the date of the actual transmission and the corresponding requested transmission date,
a processing module for determining a statistical quantity representative of the so-called lags, for each of a plurality of predetermined durations,
a processing module for determining the evolution of said statistical quantity between at least two of the so-called predetermined durations and
a processing module for comparing said evolution with a predetermined limit value.

8. A computer program, comprising instructions adapted, once implemented by a computer system, for implementing a method of tracking the evolution of a physical quantity, the method comprising the steps of:
a step of storing a plurality of dates of transmissions of numerical values requested by requests issued by so-called “requesting” entities destined for the same so-called “issuing” entity sending numerical values;
for each so-called transmission actually carried out subsequent to a so-called request, a step of storing the date of transmission and a step of determining the lag between the date of the actual transmission and the corresponding requested transmission date;
for each of a plurality of predetermined durations, a step of determining a statistical quantity representative of the so-called lags;
a step of determining the evolution of said statistical quantity between at least two of the so-called predetermined durations; and
a step of comparing said evolution with a predetermined limit value.
